(19) United States
(12) Patent Application Publication
(10) Pub. No.: US 2025/0322347 A1
(43) Pub. Date: Oct. 16, 2025

(54) Method and System for Label-Based Item Detection

(71) Applicant: ZEBRA TECHNOLOGIES CORPORATION, Lincolnshire, IL (US)

(72) Inventors: Richard M. Clayton, Manorville, NY (US); Patrick Martin Brown, North Medford, NY (US); Jason M. Gang, Plainview, NY (US); Andrew R. Calvarese, Stony Brook, NY (US); Paul Seiter, Port Jefferson Station, NY (US)

(21) Appl. No.: 18/631,856

(22) Filed: Apr. 10, 2024

(51) Int. Cl. G06Q 10/083; G06V 10/25; G06V 10/764; G06V 30/10

(52) U.S. Cl. CPC G06Q 10/083; G06V 2201/07

(57) ABSTRACT

A method includes: obtaining an image depicting a storage area containing labels disposed on a plurality of items; detecting, in the image, a first label of a first type, and a second label of a second type; extracting a first identifier from the first label; determining whether the first identifier satisfies an alert criterion; selecting, based on whether the second label is disposed on the same item as the first label, between (i) determining whether a second identifier encoded by the second label satisfies the alert criterion, and (ii) suppressing the determination of whether the second identifier satisfies the alert criterion; and controlling an output device to generate an alert according to at least one of the determination of whether the first identifier satisfies the alert criterion, and the determination of whether the second identifier satisfies the alert criterion.

### BACKGROUND

The transportation and delivery of items such as parcels to specified destinations may involve placement of the items into a container for transportation, such as a delivery vehicle, followed by sequenced retrieval and delivery of the items. Retrieving items from the vehicle for delivery may be time-consuming, reducing the efficiency of the delivery process.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for transport and delivery of items.

FIG. 2 is a flowchart of a method for label-based item detection.

FIG. 3 is a diagram illustrating an example performance of blocks 205 and 210 of the method of FIG. 2.

FIG. 4 is a diagram illustrating an example performance of blocks 220, 225, and 230 of the method of FIG. 2.

FIG. 5 is a diagram illustrating a further example performance of block 225 of the method of FIG. 2.

FIG. 6 is a diagram illustrating an example performance of block 245 of the method of FIG. 2.

FIG. 7 is a diagram illustrating an example performance of block 255 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, comprising: obtaining an image depicting a storage area containing labels disposed on a plurality of items; detecting, in the image, a first label of a first type, and a second label of a second type; extracting a first identifier from the first label; determining whether the first identifier satisfies an alert criterion; selecting, based on whether the second label is disposed on the same item as the first label, between (i) determining whether a second identifier encoded by the second label satisfies the alert criterion, and (ii) suppressing the determination of whether the second identifier satisfies the alert criterion; and controlling an output device to generate an alert according to at least one of the determination of whether the first identifier satisfies the alert criterion, and the determination of whether the second identifier satisfies the alert criterion.

Additional examples disclosed herein are directed to a computing device, comprising: a camera; and a controller configured to: obtain an image depicting a storage area containing labels disposed on a plurality of items; detect, in the image, a first label of a first type, and a second label of a second type; extract a first identifier from the first label; determine whether the first identifier satisfies an alert criterion; select, based on whether the second label is disposed on the same item as the first label, between (i) determining whether a second identifier encoded by the second label satisfies the alert criterion, and (ii) suppressing the determination of whether the second identifier satisfies the alert criterion; and control an output device to generate an alert according to at least one of the determination of whether the first identifier satisfies the alert criterion, and the determination of whether the second identifier satisfies the alert criterion.

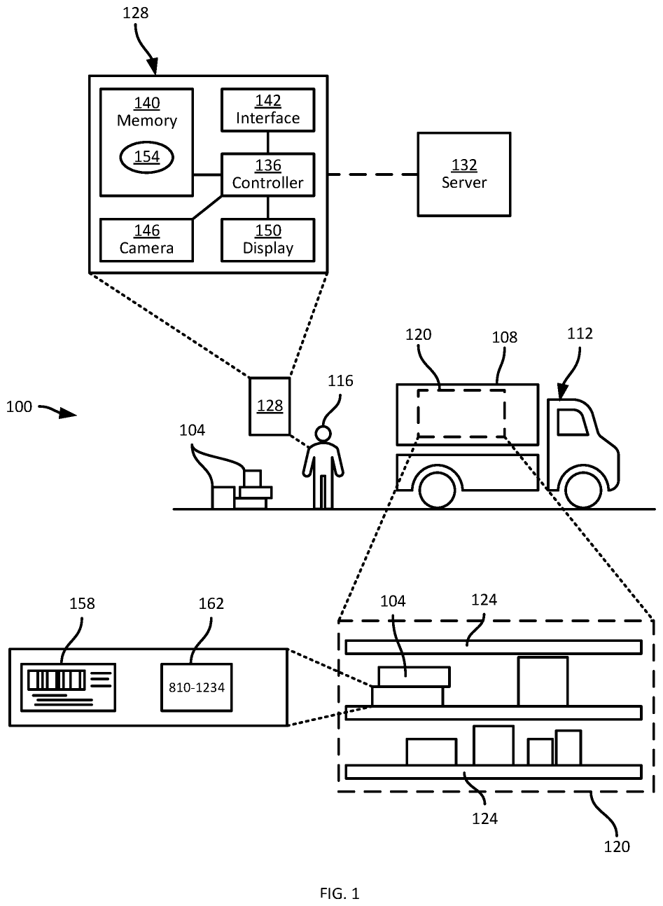

FIG. 1 depicts a system 100 for transport and delivery of items 104 such as parcels or the like to destinations such as residences, business, or the like. The transport of the items 104 to such destinations is also referred to as last mile delivery, and can be initiated by loading the items 104 into a storage area 108 of a vehicle 112. The vehicle 112, in the illustrated example, is a cube van, or the like, and the storage area 108 is the cargo area (e.g., the “box”) of the vehicle 112. A wide variety of other vehicles and corresponding storage areas are also contemplated, however. As will be apparent from the discussion below, the technologies implemented in the system 100 may also be deployed in other transport and logistics contexts beyond last mile delivery, such as for managing the loading and unloading of items 104 from shipping containers, aircraft, and the like.

The items 104 are loaded into the storage area 108, e.g., by an operator 116. In this example, the operator 116 is the operator of the vehicle 112, as well as the person responsible for removing items 104 from the vehicle 112 for delivery at various locations. In other examples, the items 104 can be loaded by a different person than the operator 116, and/or by multiple people, automated transport systems such as conveyors, or the like. A portion 120 of the storage area 108 is illustrated in FIG. 1, showing an example arrangement of the items 104 within the storage area 108. In the illustrated example, items 104 are placed on shelves 124 or other support structures, from which the items 104 are subsequently removed for delivery, e.g., when the vehicle 112 arrives at a destination.

The specific items 104 to be delivered by the operator 116 using the vehicle 112, e.g., for a given delivery route, can be defined in a manifest, which defines an ordered sequence of delivery locations (e.g., mailing addresses or the like). For each delivery location, the manifest can specify one or more item identifiers such as tracking numbers (e.g., uniquely identifying each item 104), indicating which items 104 are to be removed from the vehicle 112 and delivered to the corresponding location. The number of locations listed in the manifest, and the number of items per location (which may vary between locations), may be such that the vehicle 112 may contain tens or hundreds of items 104 for a given delivery route. The number of items 104 in the storage area 108 may be sufficient that locating one or more items 104 for a given delivery location may be a time-consuming process for the operator 116. Searching for items 104 in the storage area 108 at a given delivery location, in other words, can reduce the efficiency of the delivery process.

Some systems capture loaded locations of items 104 in the storage area 108, e.g., to provide directional guidance to the operator 116 at each delivery location. For example, such systems may instruct a loader (e.g., the operator 116 or another person) to place each item 104 at a specific position in the storage area 108. Other systems may implement processes by which the operator 116 or another suitable loader document the loaded location of each item 104 as the items 104 are being loaded. The above systems may, therefore, build a map of the items 104 within the storage area 108. Such a map can also be referred to as a realogram. However, items 104 can shift during transit, and the items 104 may also be moved by the operator 116 once loading is complete (e.g., to reposition certain items 104 before beginning the delivery run) and/or during transit, e.g., to retrieve other items 104 for delivery. A realogram generated by such systems once the items 104 have been loaded, in other words, may no longer be accurate when the items are being delivered.

The system 100 implements functionality to capture and process images of the storage area 108, and based on such processing, to alert the operator 116 when certain conditions are satisfied. For example, the operator 116 may be alerted when an item 104 that is indicated in the manifest as corresponding to the current delivery location (e.g., the item 104 is the next undelivered item in a sequence) appears in a captured image.

While other systems may capture images and highlight specific items within those images to facilitate searching for the items, the application of such searching and highlighting functionality to last mile delivery may be prone to various technical complications. For example, the items 104 may be placed in the storage area 108 in various orientations, such that features of the items 104 such as certain types of labels may not be consistently visible. Further, as described below, the items 104 may each bear more than one type of label, but in some cases only one of those labels may be visible, and detecting and interpreting some of the labels may be computationally intensive. The functionality provided by the system 100 may reduce the time spent searching for items 104 by the operator 116, while mitigating the computational complexity associated with identifying and highlighting items 104 in images of the storage area 108.

The system 100 includes a computing device 128, such as a mobile device carried or worn by the operator 116. The device 128 is configured, as discussed below, to capture images of portions of the storage area 108 during loading and/or delivery operations, and to process the images to identify the items 104. The items 104, however, may have a wide variety of shapes, colors, and orientations, and may also be partially hidden by other items. Rather than detect the items 104 themselves, therefore, the device 128 is configured to detect certain classes or types of labels disposed on the items 104, as discussed below. The system 100 can also include another computing device, such as a server 132, from which the device 128 can obtain the manifest mentioned above and/or other data, and to which the device 128 can transmit data obtained via processing of the images.

The device 128 includes a controller 136, such as a central processing unit (CPU), graphics processing unit (GPU) or the like, connected with a non-transitory computer readable medium such as a memory 140. The controller 136 and the memory 140 are implemented as one or more integrated circuits (ICs). The device 128 also includes a communications interface 142 enabling communication between the device 128 and other computing devices, such as the server 132, via suitable short-range links, networks, and the like. The device 128 includes a camera 146 configured to capture images, e.g., for processing by the controller 136. The device 128 further includes a display 150, controllable to present notifications and other information to the operator 116. The device 128 can include additional output devices, such as a speaker, a haptic output such as a motor to vibrate the device 128, or the like. The device 128 can also include other sensors in some examples, such as a radio frequency identifier (RFID) reader, a motion sensor such as an inertial measurement unit (IMU), and the like.

The memory 140 stores a plurality of applications executable by the controller 136, including an item locating application 154 whose execution by the controller 136 configures the controller 136 to perform various actions to capture images of the storage area 108, detect the items 104 therein, and under some conditions, generate alerts, notifications, or the like, for the operator 116 and/or the server 132 based on the detected items 104. The functionality implemented via execution of the application 154 can also be implemented via a distinct, special-purpose controller such as a field-programmable gate array (FPGA), application-specific integrated circuit (ASIC), or the like, in other examples.

The device 128 is configured, via execution of the application 154, to detect labels disposed on the items 104 (e.g., affixed by adhesive, printed on the items 104, or the like), from which the presence of the items 104 themselves can be inferred. Each item 104 can include a primary or main label 158, also referred to as a shipping label. The main label 158 contains information such as a unique identifier for the item 104 (e.g., a tracking number), and a mailing address indicating the destination to which the item 104 is to be delivered. The main label 158 can include various other information, such as a recipient name, a date the label was generated, a sender mailing address, and the like. Some or all of the above information can be encoded in a machine-readable indicium, such as a one- or two-dimensional barcode included on the label 158.

Each item 104 can also include an auxiliary label 162, which can also be referred to as a “vision label”, “preload assist label”, or the like. The auxiliary label 162 may omit some or all of the information contained on the main label 158. In the illustrated example, the auxiliary label 162 includes a route identifier (e.g., “810”), shared by each item 104 designated for placement in the vehicle 112 for a given delivery route, and a stop identifier (e.g., “1234”), which can correspond to a particular delivery location on the delivery route. Certain items 104 may therefore share both of the above values (e.g., if the items 104 are destined for the same location). In some examples, the auxiliary label 162 can also include an item identifier such as a portion of the corresponding tracking number, e.g., the final four digits or the like. In other words, an identifier such as a partial tracking number on an auxiliary label 162 need not uniquely identify the corresponding item 104.

The auxiliary labels 162, having less information presented thereon, generally in plain text, may facilitate visual searches for items 104 by the operator 116. The main label 158, while containing a greater volume of information, may present such information in smaller text and/or in a form that is not directly readable by the operator 116 (e.g., in the form of a barcode). Some items may lack an auxiliary label 162, or the label 162 may be obscured, however. The device 128 is configured to search images captured via the camera 146 for both label types, to increase the likelihood of locating a given item 104 when one of the labels 158 or 162 for that item 104 is missing, obscured, or the like.

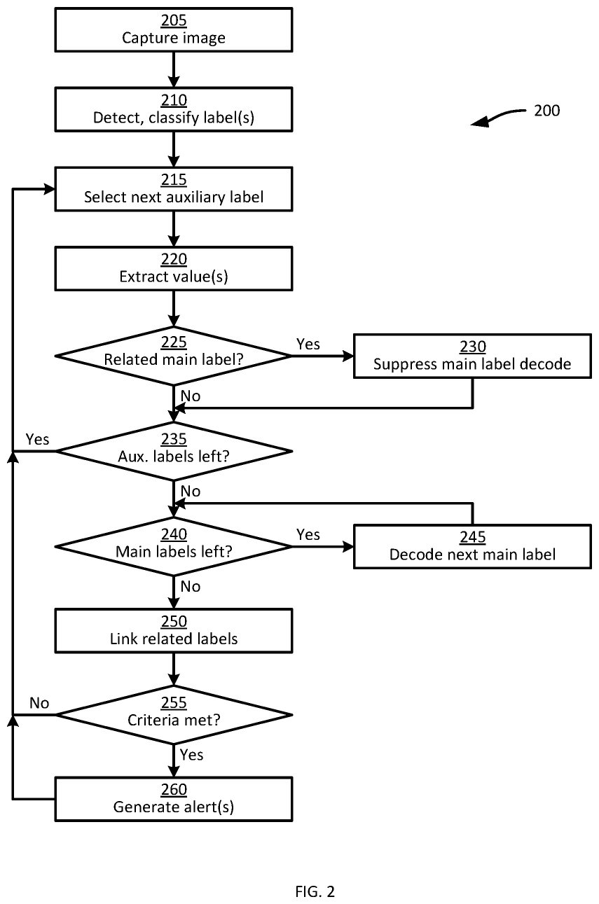

Turning to FIG. 2, a method 200 of label-based item detection is shown. The method 200 will be described in conjunction with its performance in the system 100, and in particular by the device 128, via execution of the application 154.

At block 205, the device 128 is configured to capture an image depicting a portion of the storage area 108 with the camera 146. In some examples, the performance of block 205 can be initiated via an input by the operator 116, such as a selection of a capture icon on the display 150, the depression of a button of the device 128, or the like. In some examples, the input can initiate the capture of a video stream via the camera 146 as the operator 116 moves about the storage area 108, and block 205 can therefore include the selection of a frame from the video stream. In other examples, the performance of block 205 need not be initiated by an explicit input from the operator 116. Instead, the device 128 can be configured to automatically capture a video stream for processing via the method 200.

At block 210, the device 128 is configured to detect and classify the labels 158 and 162 depicted in the image from block 205. For example, the application 154 can include an object detection and classification model, e.g., based on You Only Look Once (YOLO) or another suitable classifier. The classifier can be trained (e.g., before deployment to the device 128) with a set of annotated images depicting labels 158 and labels 162. The classifier can, in other words, detect the positions of labels 158 and 162 in the image, e.g., as a bounding box or other suitable region of interest (ROI). The classifier can also, for each region of interest, determine a class or type of label present in the region of interest. In the present example, the class indicates that the region of interest contains either a shipping (e.g., main) label, or an auxiliary label. The device 128 can generate a list or other data set representing the detected and classified labels 158 and/or 162 from block 210, for processing via the remainder of the method 200.

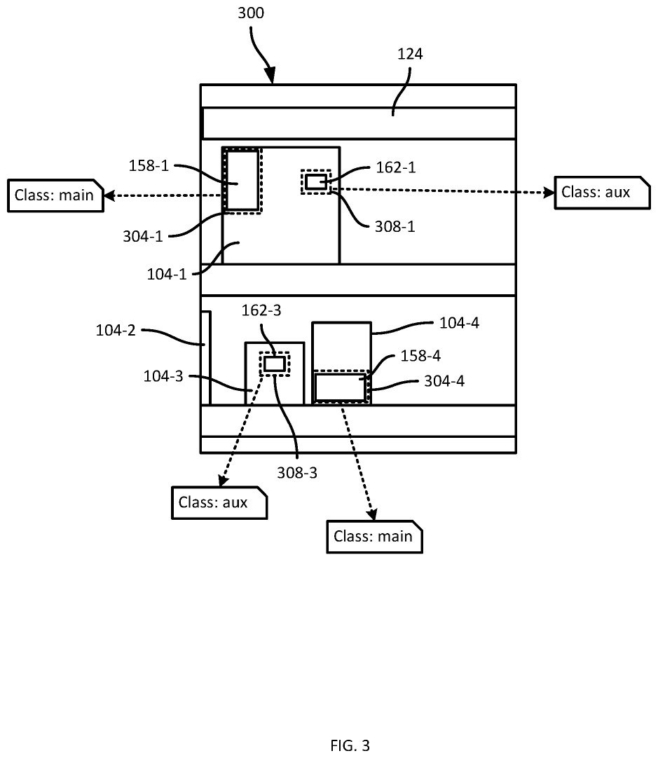

Turning to FIG. 3, an example image 300 is shown, e.g., as captured at block 205. The image 300 depicts four items 104-1, 104-2, 104-3, and 104-4 (although only a portion of the item 104-2 is visible). Via label detection and classification at block 210, the device 128 generates regions of interest corresponding to each label visible in the image 300. In the example shown in FIG. 3, the device 128 generates four regions of interest, including an ROI 304-1 corresponding to a main label 158-1 and having the class “main”, and an ROI 308-1 corresponding to the auxiliary label 162-1 and having the class “aux”. The ROIs generated at block 210 also include an auxiliary-class ROI 308-3 corresponding to the auxiliary label 162-3, and a main-class ROI 304-4 corresponding to the label 158-4. Each ROI 304 and 308 can be defined as a bounding box, e.g., with the pixel coordinates of each corner of the ROI.

Returning to FIG. 2, the device 128 is then configured to process each of the detected ROIs 304 and 308 (e.g., each of the detected labels 158 or 162). Beginning at block 215, the device 128 is configured to select one of the regions of interest 308 classified as containing an auxiliary label 162. For example, if the image contains multiple labels 158 and multiple labels 162, as in FIG. 3, the device 128 can select a label 162 (e.g., an ROI 308) at random, according to an index by which the regions of interest are stored in the memory 140, or the like. If no auxiliary labels 162 are detected in the image, the device 128 can skip the auxiliary label processing defined by blocks 215, 220, 225, 230, and 235, and proceed directly to block 240. It will also be apparent to those skilled in the art that more than one performance of the auxiliary label processing activities discussed below can be initiated concurrently, e.g., to process multiple regions of interest in parallel.

Having selected a region of interest 308 at block 215, at block 220 the device 128 is configured to extract one or more values from the region of interest 308. For example, the device 128 can perform an optical character recognition (OCR) operation on the ROI 308 selected at block 215 to extract text therefrom. The application 154 can, for example, implement a second classification model configured to identify sub-regions of interest within a region of interest 308, each sub-region corresponding to a value of the auxiliary label 162 (e.g., the route number, the stop number, and the portion of a tracking number). The device 128 can generate an identifier from the above-mentioned values. For example, the identifier can include a combination of the stop number and the partial tracking number. In some examples, the device 128 can also be configured to apply corrections to the value(s) extracted at block 220. For example, the application 154 can include rules such as one or more invalid characters that do not appear in route numbers, and/or replacement characters to substitute for any invalid characters extracted from the image 300. For example, if route numbers are numeric, and a route number “1B7” is extracted from the image 300, the character “B” is invalid. The device 128 can be configured to replace the “B” with the number “8”, for example.

At block 225, the device 128 is configured to determine whether any ROI 304 classified as containing a main label is related to the auxiliary-class ROI 308 selected at block 215. ROIs, and therefore the labels contained therein, are considered related when they are disposed on the same item 104. At block 225 the device 128 therefore seeks to determine, based on the position of the ROIs 304 to the selected ROI 308, whether any of the ROIs 304 are likely to appear on the same item as the selected ROI 308.

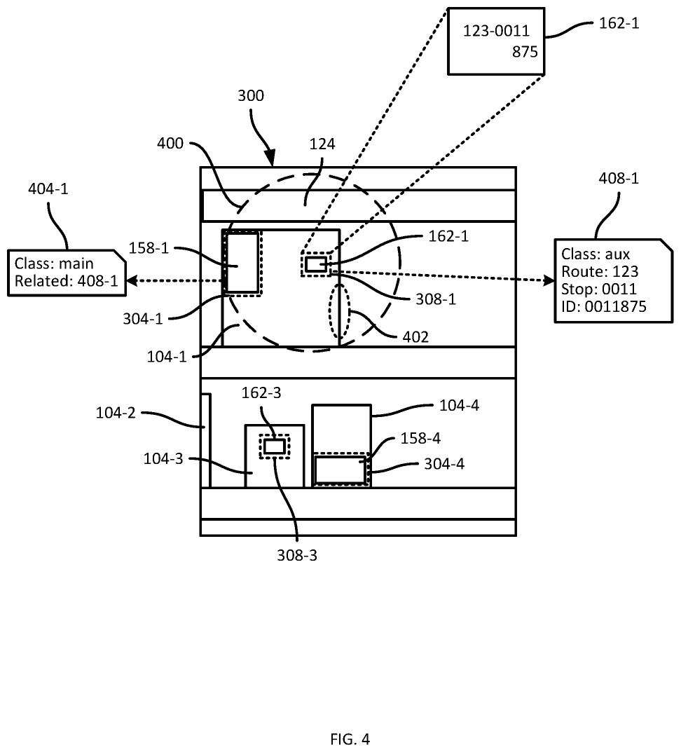

The determination at block 225 can include, for example, determining whether a distance between the selected ROI 308 and any ROI 304 is smaller than a threshold. The determination at block 225 can also include determining whether any item edges appear between the selected ROI 308 and any ROI 304. The device 128 can perform an edge-detection operation to detect edges in the image 300 that may correspond to the edges of the shelves 124 and items 104. Referring to FIG. 4, the label 162-1 is shown in greater detail as include a route number “123”, a stop number “0011”, and a partial tracking number “875”. The device 128 is configured (at block 220) to extract the above values and generate an identifier “0011875”, and to store at least the identifier in an ROI record 408-1. The ROI record 408-1 can also include pixel coordinates (not shown) of the ROI 308-1.

To determine whether any of the ROIs 304 are related to the ROI 308-1, the device 128 can determine whether any ROIs 304 are within a distance threshold 400 of the ROI 308-1. As will be apparent from FIG. 4, the ROI 304-4 is not related to the ROI 308-1 because the ROI 304-4 falls outside the distance threshold 400. The ROI 304-1, however, falls within the distance threshold 400. The device 128 can further determine whether any edges, such as the edge 402, are located between the ROI 308-1 and the ROI 304-1. Because no such edges are present in FIG. 4, the determination at block 225 is affirmative, and the device proceeds to block 230.

Returning to FIG. 2, at block 230 the device 128 is configured to suppress decoding of the main label represented by the related ROI 304. That is, referring again to FIG. 4, the device 128 can be configured to mark the ROI 304-1 as processed, without decoding the barcode thereon or performing an OCR operation thereon. For example, the device 128 can populate an ROI record 404-1 corresponding to the ROI 304-1 with a link to the ROI record 408-1. In some examples, the ROI record 408-1 can also be updated to include an identifier of the ROI record 404-1. As will be discussed below, linking ROIs permits the device 128 to bypass decoding or other processing of the ROI 304-1, thus reducing the computational impact of executing the application 154.

Referring again to FIG. 2, at block 235, after a negative determination at block 225 or after block 230, the device 128 is configured to determine whether any auxiliary labels remain to be processed in the image 300. In this example, the determination at block 235 is affirmative, and the device 128 returns to block 215 to select the next ROI 308 (e.g., the ROI 308-3 in this example). At block 220, the device 128 extracts one or more values from the ROI 308-3, and generates an identifier corresponding to the ROI 308-3, e.g., from the stop number and partial tracking number extracted. At block 225, the device 128 determines whether any main-class ROIs 304 are related to the ROI 308-3.

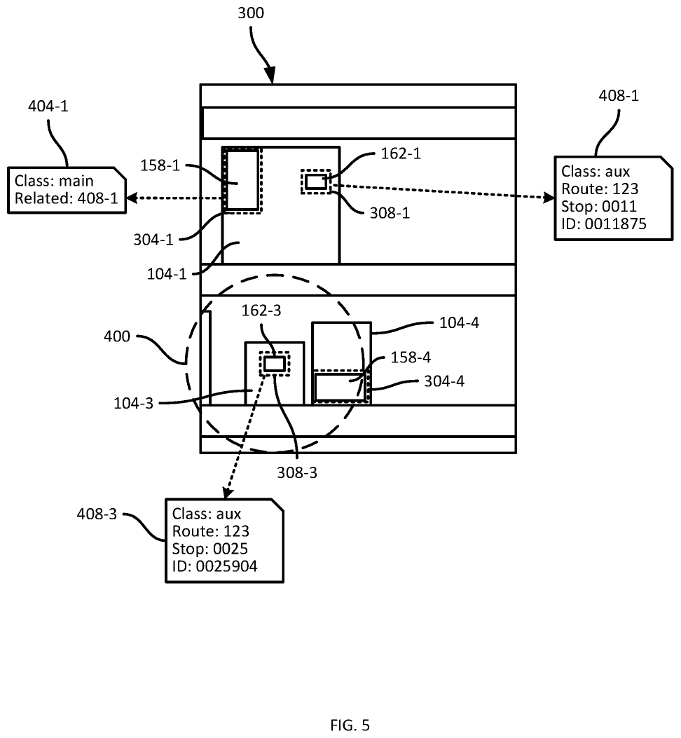

Turning to FIG. 5, the distance threshold 400 is illustrated centered on the ROI 308-3. As seen in FIG. 5, the ROI 304-4 is within the threshold distance of the ROI 308-3. However, there are edges between the ROIs 308-3 and 304-4 corresponding to the sides of the items 104-3 and 104-4. The determination at block 225 is therefore negative. An ROI record 408-3 for the ROI 308-3 is generated via blocks 215 and 220 that includes, for example, the class of the ROI 308-3, the route and stop numbers, and the above-mentioned identifier.

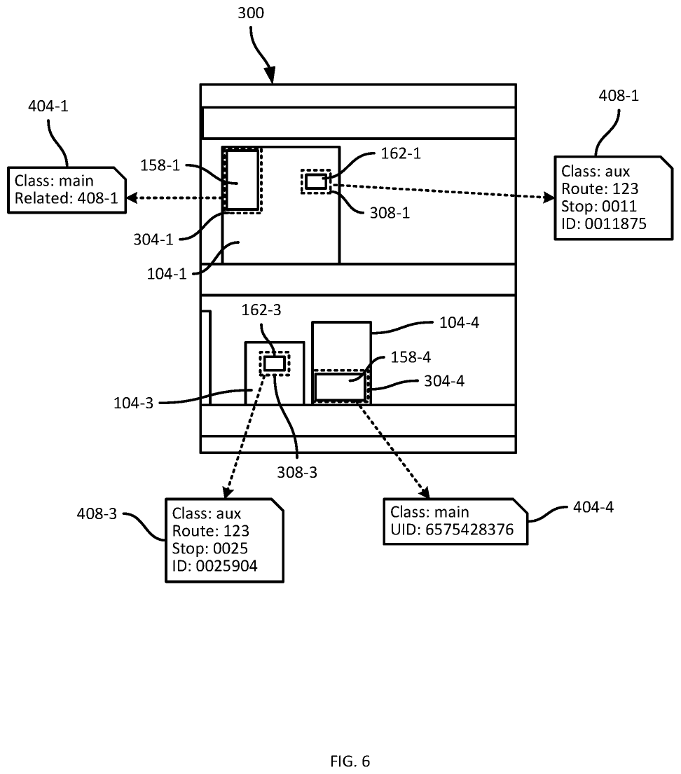

Returning again to FIG. 2, the next determination at block 235 is negative, as both ROIs 308 from the image 300 have been processed. The device 128 therefore proceeds to block 240. At block 240, the device 128 is configured to determine whether any regions of interest 304 classified as containing main labels 158 remain to be processed. A region of interest 304 remains to be processed if the region of interest 304 has not been linked to an auxiliary region of interest 308 via blocks 225 and 230, or if the region of interest 304 has not been processed via block 245, which follows an affirmative determination at block 240. FIG. 6 illustrates an ROI record 404-4 generated in connection with the ROI 304-4, containing the unique identifier (e.g., a tracking number) decoded from a barcode on the label 158-4. As will be apparent from FIG. 6, the label 158-1 has not been decoded.

In the present example, the determination at block 240 is affirmative, as the region of interest 304-4 has not been processed. At block 245, therefore, the device 128 is configured to select the next main-class region of interest 304 (corresponding to the label 158-4 in this case) and decode the barcode thereon. Decoding the barcode on a label 158 may yield, for example, a unique identifier of the corresponding item 104, such as a tracking number.

Following block 245, the device 128 is configured to return to block 240. In other words, the device 128 repeats block 245 until every region of interest 304 classified as containing a main label 158 has been decoded. Some decode operations may fail, e.g., because of insufficient image quality or the like. The device 128 can be configured to mark a region of interest 304 with a failed decode as processed, or to simply discard the region of interest 304.

Following a negative determination at block 240, indicating that all regions of interest 304 that were not previously linked to regions of interest 308 have been decoded (or failed to decode), the device 128 proceeds to block 250. At block 250, the device 128 can be configured to identify related regions of interest 304 and 308 that were not identified as related via blocks 225 and 230. For example, a large item 104 may support labels 158 and 162 at a greater distance than the threshold 400, leading to an erroneous negative determination at block 225. In other examples, an erroneous edge detection (e.g., due to imaging artifacts like shadows or the like) may lead to a negative determination at block 225 for labels 158 and 162 that are on the same item 104. In further examples, blocks 225 and 230 can be omitted, such that links are only established between regions of interest 304 and 308 at block 250.

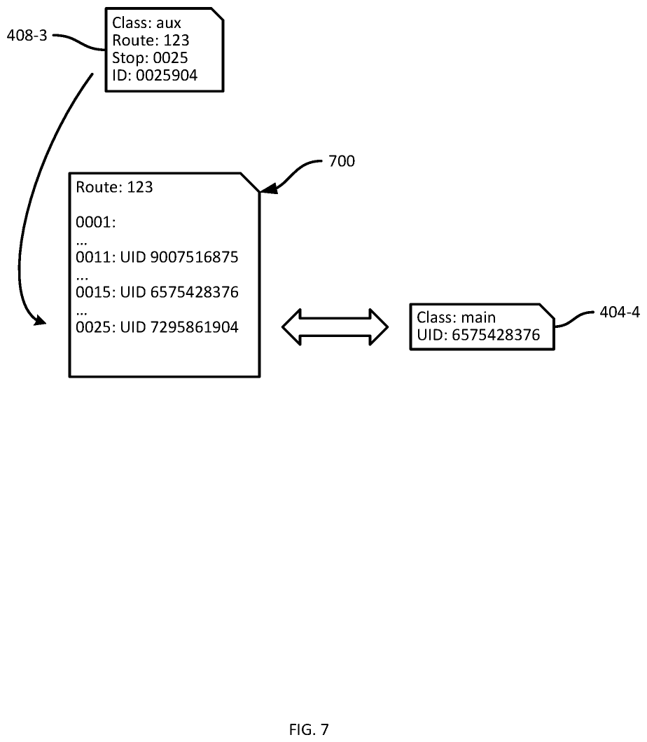

The performance of block 250 can include, for example, determining whether the unique item identifier contained in the ROI record 404-4 corresponds to an identifier of any unlinked ROI 308 (e.g., the ROI 308-3, in this example). Referring to FIG. 7, a manifest record 700 is shown, identified by a route number (e.g., “123”) and defining a sequence of stops (identified numerically in this example) and associated item identifiers. The device 128 can be configured, based on the identifier in the ROI record 408-3, to retrieve a corresponding unique ID from the manifest 700, and to determine whether the retrieved unique ID matches the unique ID of the ROI record 404-4. When the determination is negative, as in this case, the records 408-3 and 404-4 remain unlinked. When the determination is affirmative, the relevant records can be linked as described above in connection with the records 404-1 and 408-1.

Returning to FIG. 2, at block 255 the device 128 can be configured to determine whether the ROIs 304 and 308 satisfy one or more alert criteria. Various alert criteria can be provisioned in the application 154. For example, the device 128 can retrieve the next item in the sequence defined by the manifest 700, and determine whether any of the ROIs 304 and 308 correspond to that item. In a further example, the device 128 can determine whether any of the ROIs 304 and 308 correspond to an item that does not appear in the manifest 700 (e.g., indicating the presence of a misloaded item on the vehicle 112).

The determination at block 255 can include, for example, comparing each ROI 308 to the manifest 700 to determine whether the ROI 308 is the next item in the delivery sequence, or whether the manifest does not identify an item 104 corresponding to the ROI 308. The determination at block 255 can further include the same comparison for any ROI 304 that is not linked with an ROI 308. ROIs 304 that are linked with ROIs 308 may be ignored, to avoid producing redundant alerts. In other examples, linked/related ROIs 304 and 308 can be highlighted on the image 300 or otherwise presented on the display 150 in a single alter generation at block 260.

At block 260, the device 128 is configured to generate an alert for any ROI 304 or 308 that satisfies an alert criterion at block 255. For example, when an alert criterion corresponding to the next item in the delivery sequence is satisfied, at block 260 the device 128 can be configured to generate a first audible tone, present a notification on the display 150 that the next item has been located, or the like. The device 128 can present, for example, the image 300 with the relevant ROI 304 or 308 highlighted, overlaid, or the like. When an alert criterion corresponding to a misloaded item is satisfied, at block 260 the device 128 can be configured to generate a second audible tone, present an error notification on the display 150 (e.g., along with the image 300 with highlight or overlay), or the like.

In the event that more than one alert criterion is satisfied for a given image (e.g., if the image contains both a misloaded item and one or more items for a current delivery location), the device 128 can be configured to stage the alerts, e.g., presenting one alert along with a prompt for the operator 116 to acknowledge the alert, before presenting the next alert. Following the generation of alerts at block 260, or following a negative determination at block 255, the device 128 can return to block 205 to capture another image.

In further examples, the device 128 can be configured to detect and classify more than two labels of classes, e.g., if a given implementation includes two distinct types of auxiliary labels, or the like. In such examples, the device 128 can be configured to determine relatedness between a given class (e.g., the auxiliary labels 162) and either or both of the other classes of labels expected to appear on the items 104.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
training a classifier, based on an image dataset, to detect a first label of a first type, and a second label of a second type;
obtaining, by a controller, an image captured by a camera depicting a storage area containing labels disposed on a plurality of items;
detecting, in the image, the first label of the first type, and the second label of the second type by executing the classifier to generate a first region of interest corresponding to the first label, and a second region of interest corresponding to the second label;
extracting a first identifier from the first label;
determining whether the first identifier satisfies an alert criterion;
selecting, based on whether the second label is disposed on the same item as the first label, between (i) determining whether a second identifier encoded by the second label satisfies the alert criterion, and (ii) suppressing the determination of whether the second identifier satisfies the alert criterion; and
controlling an output device to generate an alert according to at least one of the determination of whether the first identifier satisfies the alert criterion, and the determination of whether the second identifier satisfies the alert criterion.

2. (canceled)

3. The method of claim 1, wherein the first type is an auxiliary label including the first identifier; and wherein the second type is a shipping label including the second identifier.

4. The method of claim 1, wherein extracting the first identifier from the first label includes:
executing an optical character recognition model to extract at least one of:
a delivery route identifier, a delivery stop identifier, or a partial unique identifier corresponding to one of the items.

5. The method of claim 1, wherein determining that the second label is disposed on the same item as the first label includes:
determining that a distance in the image between the first label and the second label is below a threshold; and
determining that the first label and the second label are not separated by an edge of one of the items.

6. The method of claim 1, wherein determining whether the second label is disposed on the same item as the first label includes:
decoding a unique identifier of the item from the second label; and
determining that the unique identifier and the first identifier extracted from the first label correspond to the same item.

7. The method of claim 1, wherein determining whether the first identifier satisfies the alert criterion includes:
retrieving, from a delivery sequence for the plurality of items, a next item in the delivery sequence; and
determining whether the first identifier corresponds to the next item.

8. The method of claim 1, wherein determining that the first identifier satisfies the alert criterion includes:
determining that the first identifier is not included in a delivery sequence for the plurality of items.

9. A computing device, comprising:
a camera; and
a controller configured to:
train a classifier, based on an image dataset, to detect a first label of a first type, and a second label of a second type;
obtain an image captured by the camera depicting a storage area containing labels disposed on a plurality of items;
detect, in the image, the first label of the first type, and the second label of the second type by executing the classifier to generate a first region of interest corresponding to the first label, and a second region of interest corresponding to the second label;
extract a first identifier from the first label;
determine whether the first identifier satisfies an alert criterion;
select, based on whether the second label is disposed on the same item as the first label, between (i) determining whether a second identifier encoded by the second label satisfies the alert criterion, and (ii) suppressing the determination of whether the second identifier satisfies the alert criterion; and
control an output device to generate an alert according to at least one of the determination of whether the identifier satisfies the alert criterion, and the determination of whether the second identifier satisfies the alert criterion.

10. (canceled)

11. The computing device of claim 9, wherein the first type is an auxiliary label including the first identifier; and wherein the second type is a shipping label including the second identifier.

12. The computing device of claim 9, wherein the controller is configured to extract the first identifier from the first label by:
executing an optical character recognition model to extract at least one of:
a delivery route identifier, a delivery stop identifier, or a partial unique identifier corresponding to one of the items.

13. The computing device of claim 9, wherein the controller is configured to determine that the second label is disposed on the same item as the first label by:
determining that a distance in the image between the first label and the second label is below a threshold; and
determining that the first label and the second label are not separated by an edge of one of the items.

14. The computing device of claim 9, wherein the controller is configured to determine whether the second label is disposed on the same item as the first label by:
decoding a unique identifier of the item from the second label; and
determining that the unique identifier and the first identifier extracted from the first label correspond to the same item.

15. The computing device of claim 9, wherein the controller is configured to determine whether the first identifier satisfies the alert criterion by:
retrieving, from a delivery sequence for the plurality of items, a next item in the delivery sequence; and
determining whether the first identifier corresponds to the next item.

16. The computing device of claim 9, wherein the controller is configured to determine that the first identifier satisfies the alert criterion by:
determining that the first identifier is not included in a delivery sequence for the plurality of items.
